(19) United States
(12) Patent Application Publication
(10) Pub. No.: US 2016/0356445 A1
(43) Pub. Date: Dec. 8, 2016

(54) VEHICLE ILLUMINATION APPARATUS

(71) Applicant: Coretronic Corporation, Hsin-Chu (TW)

(72) Inventors: Chi-Tang Hsieh, Hsin-Chu (TW); Han-Wen Tsai, Hsin-Chu (TW)

(21) Appl. No.: 15/013,992

(22) Filed: Feb. 2, 2016

(30) Foreign Application Priority Data
Jun. 3, 2015 (TW) 104117949

(51) Int. Cl. F21S 8/10

(52) U.S. Cl. CPC F21S 48/1241; F21S 48/1154; F21S 48/125

(57) ABSTRACT

A vehicle illumination apparatus including a light guide bar, at least one light source, and a lens is provided. The light guide bar has at least one light incidence surface and a light emitting surface, and a shape of the light emitting surface is a polygon having an interior angle not smaller than 180 degrees. The at least one light source is disposed adjacent to the at least one light incidence surface. The lens is disposed adjacent to the light emitting surface and has an optical axis and a light incidence recess. The light incidence recess faces the light guide bar and has a light incidence opening, wherein a cross-sectional area of the light incidence opening on a first reference plane perpendicular to the optical axis is greater than an area of the light emitting surface of the light guide bar.

### CROSS-REFERENCE TO RELATED APPLICATION

This application claims the priority benefit of Taiwan application serial no. 104117949, filed on Jun. 3, 2015. The entirety of the above-mentioned patent application is hereby incorporated by reference herein and made a part of this specification. Meanwhile, Taiwan application serial no. 101135356 “ILLUMINATION APPARATUS USED IN VEHICLE” and Taiwan application serial no. 102115919 “ILLUMINATION APPARATUS USED IN VEHICLE” are related to this application.

### BACKGROUND OF THE INVENTION

Field of the Invention

The invention relates to an illumination apparatus, and particularly relates to a vehicle illumination apparatus.

Description of Related Art

Besides that a light pattern projected by a vehicle illumination apparatus is required to be complied with requirements of related regulations on illumination range and illuminance, it should also have a clear cut-off line, so as to avoid a situation that an approaching vehicle produces a glare to influence driving safety. The existing vehicle low beam mainly adopts a light shielding plate to form the clear cut-off line, though disposition of the light shielding plate greatly decreases utilization of light. On the other hand, if the light shielding plate is not disposed, it is hard to form the clear cut-off line. Therefore, how to form the clear cut-off line without greatly decreasing utilization of light is a target to be achieved by researchers of ordinary skill in the art.

The information disclosed in this “Description of Related Art” section is only for enhancement of understanding of the background of the invention and therefore it may contain information that does not form the prior art that is already known to a person of ordinary skill in the art. Furthermore, the information disclosed in this “Description of Related Art” section does not mean that one or more problems to be resolved by one or more embodiments of the invention were acknowledged by a person of ordinary skill in the art.

### SUMMARY OF THE INVENTION

The invention is directed to a vehicle illumination apparatus, which is adapted to form a clear cut-off line without greatly decreasing utilization of light.

Other objects and advantages of the invention can be further illustrated by the technical features broadly embodied and described as follows.

In order to achieve at least one or all of the objects or other objects, an embodiment of the invention provides a vehicle illumination apparatus including a light guide bar, at least one light source and a lens. The light guide bar has at least one light incidence surface and a light emitting surface, and a shape of the light emitting surface is a polygon having an interior angle not smaller than 180 degrees. The at least one light source is disposed adjacent to the at least one light incidence surface. The lens is disposed adjacent to the light emitting surface and has an optical axis, a light incidence recess and a light projection surface opposite to the light incidence recess. The light incidence recess faces the light guide bar and has a light incidence opening, wherein a cross-sectional area of the light incidence opening on a first reference plane perpendicular to the optical axis is greater than an area of the light emitting surface of the light guide bar.

In an embodiment of the invention, an area of the light incidence surface of the light guide bar is greater than or equal to the area of the light emitting surface.

In an embodiment of the invention, a shape of the light incidence surface of the light guide bar is different from the shape of the light emitting surface.

In an embodiment of the invention, a shape of the light incidence surface of the light guide bar is the same to the shape of the light emitting surface.

In an embodiment of the invention, the at least one light source is adapted to emit a light beam to enter the light guide bar through the light incidence surface, and leave the light guide bar through the light emitting surface and is transmitted to the light incidence recess to enter the lens, and leave the lens through the light projection surface.

In an embodiment of the invention, the light incidence surface and the light emitting surface of the light guide bar are parallel to each other, and the light incidence surface and the light emitting surface are perpendicular to the optical axis.

In an embodiment of the invention, the light incidence surface and the light emitting surface of the light guide bar are not parallel to each other.

In an embodiment of the invention, the light guide bar is a solid structure.

In an embodiment of the invention, the light guide bar is a hollow structure, the light guide bar has an inner wall, and a reflection layer is formed on the inner wall.

In an embodiment of the invention, the number of the at least one light incidence surface and the number of the at least one light source are respectively two or more.

In an embodiment of the invention, the number of the at least one light incidence surface corresponds to the number of the at least one light source.

In an embodiment of the invention, the light source comprises at least one light emitting element.

In an embodiment of the invention, a distance between the light emitting surface of the light guide bar and the light incidence opening on the optical axis is greater than or equal to 0.

In an embodiment of the invention, the lens further has a main light spreading surface, a secondary light spreading surface and a light converging surface, where the optical axis passes through the main light spreading surface, the secondary light spreading surface surrounds the main light spreading surface, and the light converging surface surrounds the secondary light spreading surface.

In an embodiment of the invention, the main light spreading surface is a curved surface protruding towards the light incidence opening.

In an embodiment of the invention, the secondary light spreading surface is a curved surface or an inclined surface, and the light converging surface is a curved surface or an inclined surface.

In an embodiment of the invention, the main light spreading surface is asymmetric to a second reference plane parallel to the optical axis.

According to the above descriptions, the embodiment of the invention has at least one of the following advantages and effects. The light beam output by the light source first passes through the light guide bar and then enters the lens, and the light emitting surface of the light guide bar can be regarded as a virtual light source, and by changing a shape of the light emitting surface of the light guide bar, a light pattern output from the lens is adjusted. In this way, the vehicle illumination apparatus of the invention may form a clear cut-off line without using a light shielding plate, so as to mitigate decrease of utilization of light of the conventional technique. Moreover, by designing the area of the light emitting surface of the light guide bar to be smaller than the cross-sectional area of the light incidence opening, the light emitting surface is equivalent to a point light source relative to the lens, such that a light beam collimating effect of the lens is improved, which avails making the light pattern projected by the vehicle illumination apparatus to be complied with the requirement of related regulation.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional view of a vehicle illumination apparatus according to a first embodiment of the invention.

FIG. 1B is a front view of a light emitting surface of a light guide bar of FIG. 1A.

FIG. 1C is a schematic diagram of a light pattern projected by the vehicle illumination apparatus of FIG. 1A.

FIG. 2A is a schematic diagram of a first implementation of the light guide bar of FIG. 1A.

FIG. 2B and FIG. 2C are respectively front views of a light incidence surface and a light emitting surface of the light guide bar of FIG. 2A.

FIG. 3A is a schematic diagram of a second implementation of the light guide bar of FIG. 1A.

FIG. 3B is a front view of a light incidence surface of the light guide bar of FIG. 3A.

FIG. 3C is a cross-sectional view of the light guide bar of FIG. 3A at a cross section A.

FIG. 3D is a front view of a light emitting surface of the light guide bar of FIG. 3A.

FIG. 4 to FIG. 6 are respectively schematic diagrams of a third to a fifth implementations of the light guide bar of FIG. 1A.

FIG. 7A is a cross-sectional view of a vehicle illumination apparatus according to a second embodiment of the invention.

FIG. 7B is a schematic diagram of a light pattern projected by the vehicle illumination apparatus of FIG. 7A.

FIG. 8 is another cross-sectional view of a lens of FIG. 7A.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

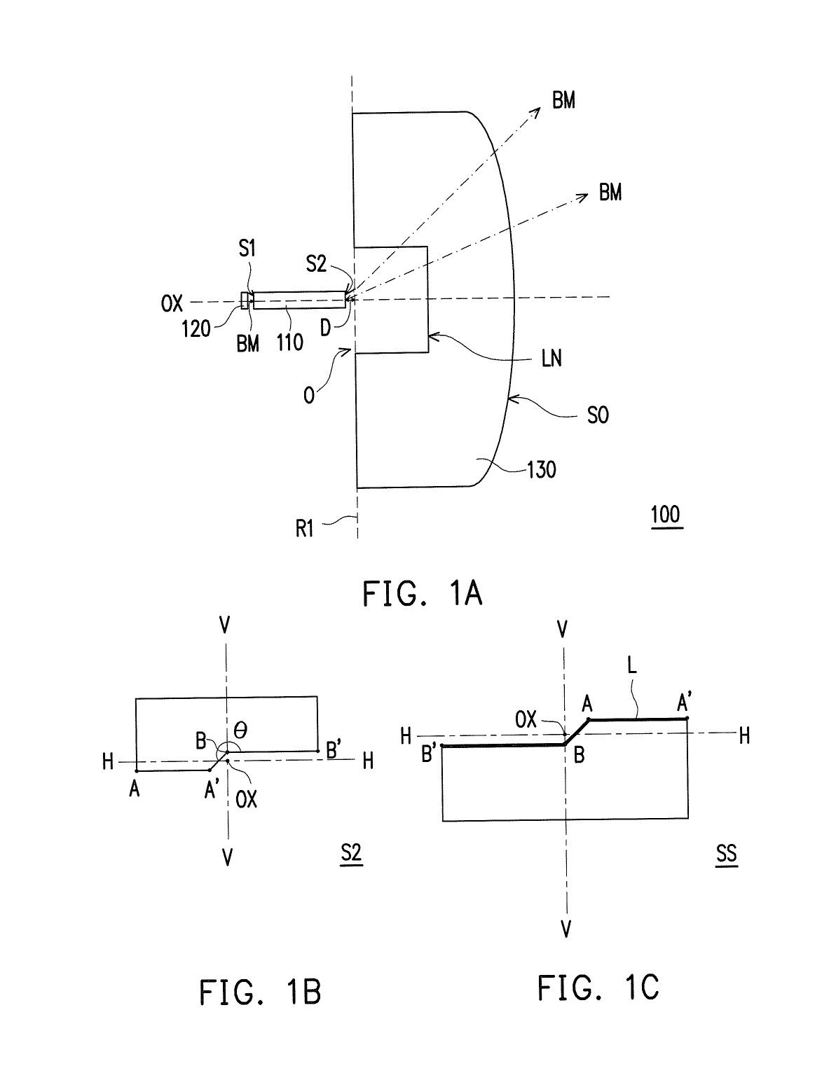

FIG. 1A is a cross-sectional view of a vehicle illumination apparatus according to a first embodiment of the invention. FIG. 1B is a front view of a light emitting surface of a light guide bar of FIG. 1A. FIG. 1C is a schematic diagram of a light pattern projected by the vehicle illumination apparatus of FIG. 1A. Referring to FIG. 1A to FIG. 1C, a vehicle illumination apparatus 100 includes a light guide bar 110, at least one light source 120 and a lens 130.

The light guide bar 110 has at least one light incidence surface S1 and a light emitting surface S2. As shown in FIG. 1A, the light guide bar 110 can be a solid structure, wherein the light incidence surface S1 and the light emitting surface S2 are opposite to each other. A shape of the light incidence surface S1 can be varied along with a design of the light source 120. In the embodiment, the shape of the light incidence surface S1 is the same to a shape of the light emitting surface S2, and an area of the light incidence surface S1 is the same to an area of the light emitting surface S2, though the invention is not limited thereto.

The shape of the light emitting surface S2 is a polygon having an interior angle θ not smaller than 180 degrees. To be specific, the shape of the light emitting surface S2 can be complied with an asymmetric light pattern of 112^{th} regulation (which is referred to as R112) of economic commission of Europe (ECE). As shown in FIG. 1B, the shape of the light emitting surface S2 can be a concave hexagon, and the interior angle 0 can be 225 degrees, though the invention is not limited thereto.

The light source 120 is disposed adjacent to the light incidence surface S1, and is adapted to emit a light beam BM towards the light incidence surface S1. For example, the light source 120 may include at least one light emitting element (not shown) and at least one circuit board (not shown). The light emitting element is, for example, a light emitting diode (LED) and is disposed on the circuit board, and a quantity ratio between the light emitting elements and the circuit boards can be one-to-one or many-to-one, though the invention is not limited thereto, and the light emitting elements can also be laser diodes or other suitable light sources, and a plurality of the light emitting elements can be disposed on the same circuit board.

The light beam BM emitted by the light source 120 enters the light guide bar 110 through the light incident surface S1, and leaves the light guide bar 110 through the light emitting surface S2 and is transmitted to a light incidence recess LN of the lens 130 for entering the lens 130. The lens 130 is disposed adjacent to the light emitting surface S2 of the light guide bar 110, and the light beam BM coming from the light emitting surface S2 is adapted to leave the lens 130 through a light projection surface SO, and is projected to external of the vehicle illumination apparatus 100. Taking a low beam as an example, a light pattern SS of FIG. 1C is, for example, a light pattern projected by the vehicle illumination apparatus 100 on a plane perpendicular to the ground and located in front of the vehicle by 25 meters. Since the vehicle illumination apparatus 100 uses the lens 130 to faun a real image in front of the vehicle, the light pattern SS projected by the vehicle illumination apparatus 100 is similar to the shape of the light emitting surface S2, and the shape of the light emitting surface S2 is upside down and left-side right relative to the light pattern SS (shown in FIG. 1B and FIG. 1C). In this way, by changing the shape of the light emitting surface S2 of the light guide bar 110, the light pattern SS projected by the lens 130 can be adjusted, and a clear cut-off line L can be formed in the light pattern SS. In other words, the vehicle illumination apparatus 100 is unnecessary to adopt a light shielding plate to shield a part of the light beam BM to form the clear cut-off line L. Therefore, the vehicle illumination apparatus 100 may produce the clear cut-off line L without greatly decreasing utilization of light from the light source 120.

Referring to FIG. 1A, the lens 130 is, for example, a total internal reflection (TIR) lens having reflection surfaces, and the lens 130 has an optical axis OX, the light incidence recess LN and the light projection surface SO opposite to the light incidence recess LN. The light incidence recess LN faces the light guide bar 110 and has a light incidence opening O, wherein a cross-sectional area of the light incidence opening O on a first reference plane R1 perpendicular to the optical axis OX is greater than an area of the light emitting surface S2 of the light guide bar 110. Since the lens 130 can effectively collimate the light beam BM coming from the light source 120, by suitably designing the lens 130 (for example, modifying a design of the total internal reflection surfaces of the lens 130), the light pattern SS projected by the vehicle illumination apparatus 100 can be complied with the requirement of related regulation. To be specific, as shown in FIG. 1C, if the optical axis OX is taken as a center to draw a horizontal line H-H, and a vertical lien V-V perpendicular to each other, regarding a left-hand driving, a horizontal line section A-A′ of the cut-off line L located to the right of the vertical line V-V is located above the horizontal line H-H, and a horizontal line section B-B′ of the cut-off line L located to the left of the vertical line V-V is located below the horizontal line H-H.

In the embodiment, the light emitting surface S2 of the light guide bar 110 and the light incidence opening O of the light incidence recess LN are spaced by a distance D on the optical axis OX. However, the invention is not limited thereto, and in another embodiment, the distance D between the light emitting surface S2 and the light incidence opening O on the optical axis OX can also be equal to 0. In other words, the light emitting surface S2 and the light incidence opening O can be aligned to each other. Since relative positions of the light emitting surface S2 and the lens 130 can be accurately aligned through mechanism assembling, an error produced in light emitting element packaging and a tolerance in assembling of the light emitting element and the circuit board can be compensated. As such, an optical effect of the vehicle illumination apparatus 100 can be improved.

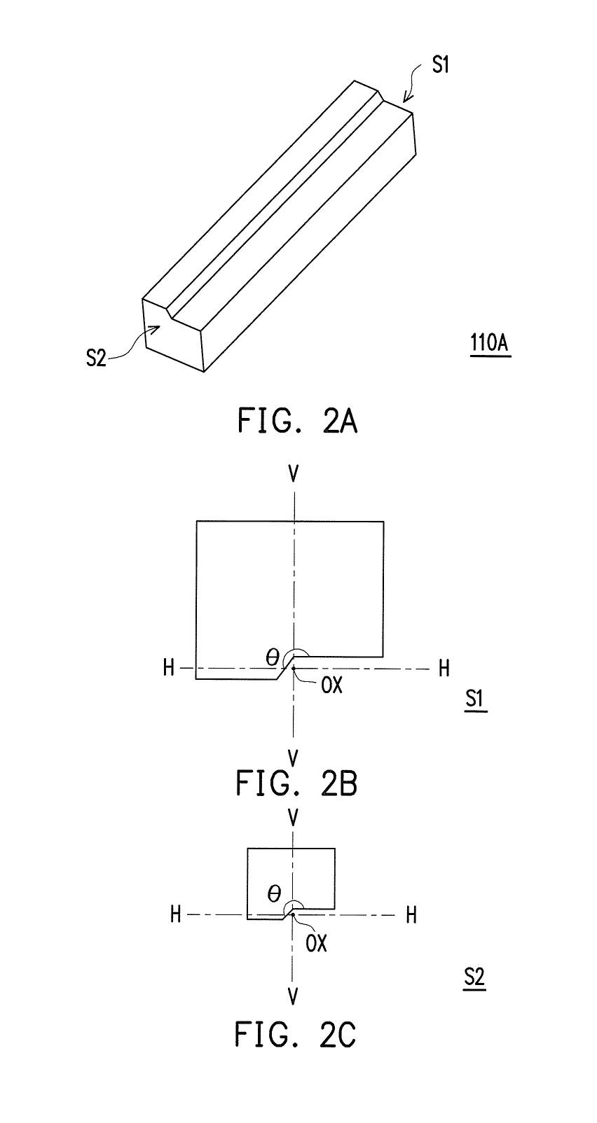

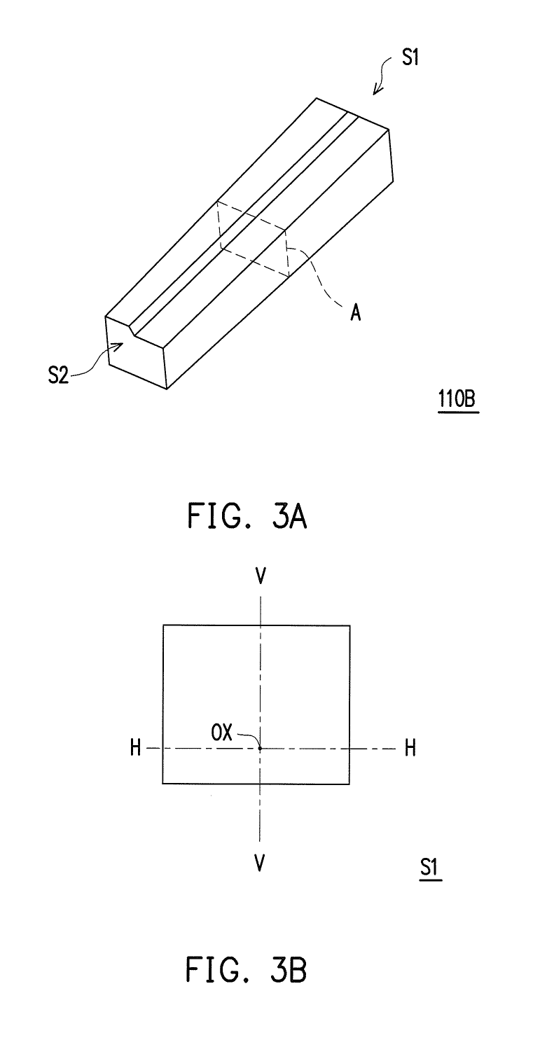

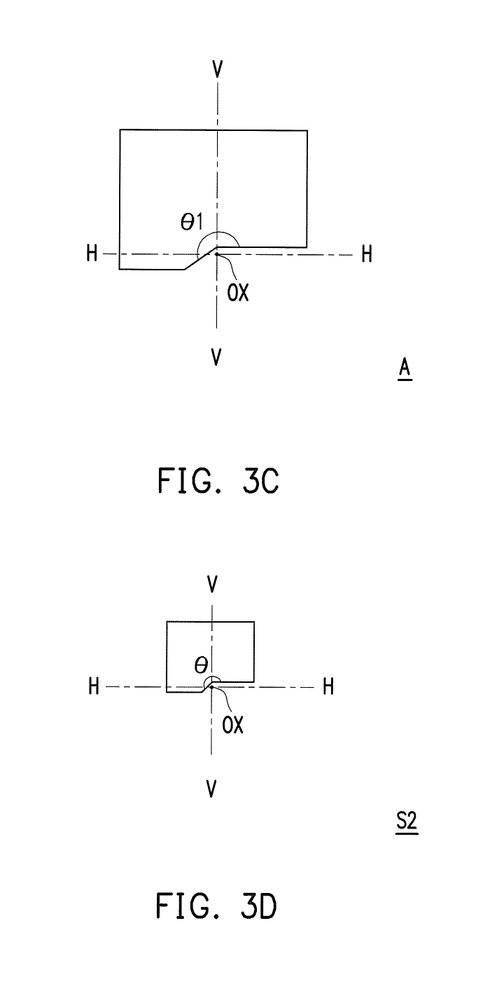

Other implementations of the light guide bar of FIG. 1A are described below with reference of FIG. 2A to FIG. 6. FIG. 2A is a schematic diagram of a first implementation of the light guide bar of FIG. 1A. FIG. 2B and FIG. 2C are respectively schematic diagrams of a light incidence surface and a light emitting surface of the light guide bar of FIG. 2A. FIG. 3A is a schematic diagram of a second implementation of the light guide bar of FIG. 1A. FIG. 3B is a schematic diagram of a light incidence surface of FIG. 3A. FIG. 3C is a cross-sectional view of the light guide bar of FIG. 3A at a cross section A. and a light emitting surface of the light guide bar FIG. 3D is a schematic diagram of a light emitting surface of the light guide bar of FIG. 3A. FIG. 4 to FIG. 6 are respectively schematic diagrams of a third to a fifth implementations of the light guide bar of FIG. 1A. As shown in FIG. 2A to FIG. 2C, the light guide bar 110A can be a solid structure, wherein an area of the light incidence surface S1 of the light guide bar 110A can be greater than an area of the light emitting surface S2, and a shape of light incidence surface S1 of the light guide bar 110A can be the same to a shape of the light emitting surface S2. As shown in FIG. 3A to FIG. 3D, the light guide bar 110B is similar to the light guide bar 110A, and a difference therebetween is that the shape of light incidence surface S1 of the light guide bar 110B can be different from the shape of the light emitting surface S2. For example, the shape of light incidence surface S1 can be a rectangle, and the light incidence surface S1 is parallel to the light emitting surface S2, wherein an area of a cross section A located between the light incidence surface S1 and the light emitting surface S2 and parallel to the light incidence surface S1 and the light emitting surface S2 is, for example, progressively decreased along a direction from the light incidence surface S1 to the light emitting surface S2, and an interior angle θ is progressively increased from 180 degrees to 225 degrees. For example, the interior angle θ1 of the cross section A is between 180 degrees and 225 degrees. According to such design, the light guide bar 110b may have better formability during a manufacturing process (for example, the light guide bar is manufactured through injection molding).

As shown in FIG. 4, the light guide bar 110C is similar to the aforementioned light guide bars 110A and 110B, and a difference therebetween is that the light guide bar 110C can be a hollow structure, and a reflection layer is formed on an inner wall SI of the light guide bar 110C. In this way, the light beam BM emitted by the light source 120 can be transmitted in the light guide bar 110C by reflection. In the aforementioned embodiment, the area of the light incidence surface S1 can be changed along with the light emitting elements of different specifications so that the light source 120 may adopt the light emitting elements of different specifications according to different design requirements. The inner wall SI, for example, may coated with silver, aluminium, gold or the other materials that has high reflection rate, the invention is not limited thereto.

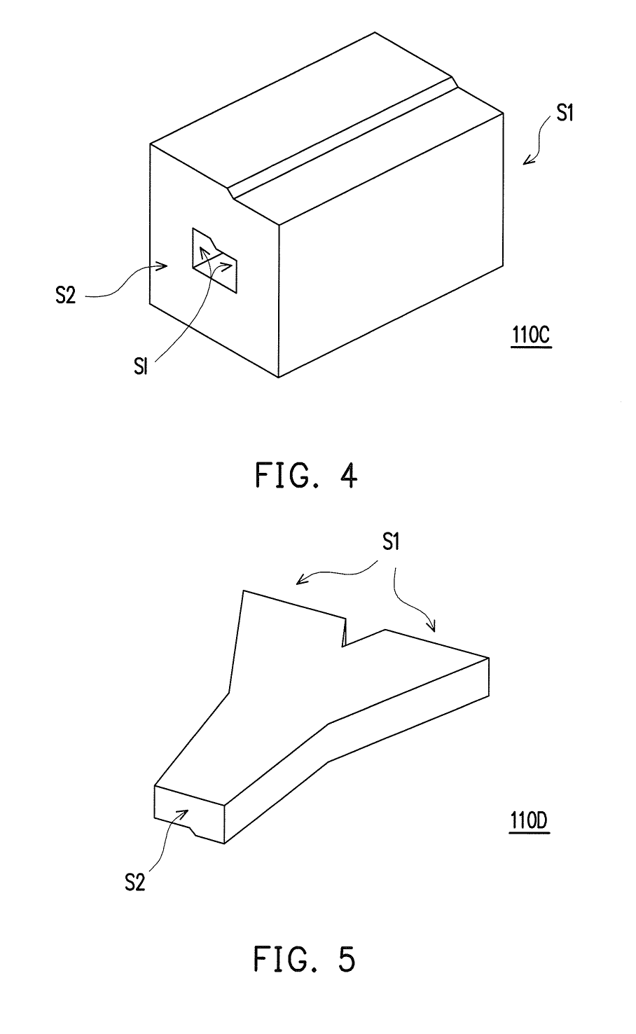

As shown in FIG. 5, the light guide bar 110D is similar to the aforementioned light guide bars 110A-110C, and a difference therebetween is that the light guide bar 110D has a plurality of light incidence surfaces S1 (two light incidence surfaces S1 are illustrated), and each of the light incidence surfaces S1 is connected to the light emitting surface S2. Under such architecture, the number of the light sources 120 in FIG. 1A can be correspondingly adjusted to be two or more, and preferably the number of the light incidence surfaces S1 corresponds to the number of the light sources. In the embodiment, since brightness of the light emitting surface S2 can be enhanced by increasing the number of the light incidence surfaces S1 without increasing the number of the lens 130, the whole volume and cost of the vehicle illumination apparatus 100 are prevented from greatly increasing while the brightness is enhanced.

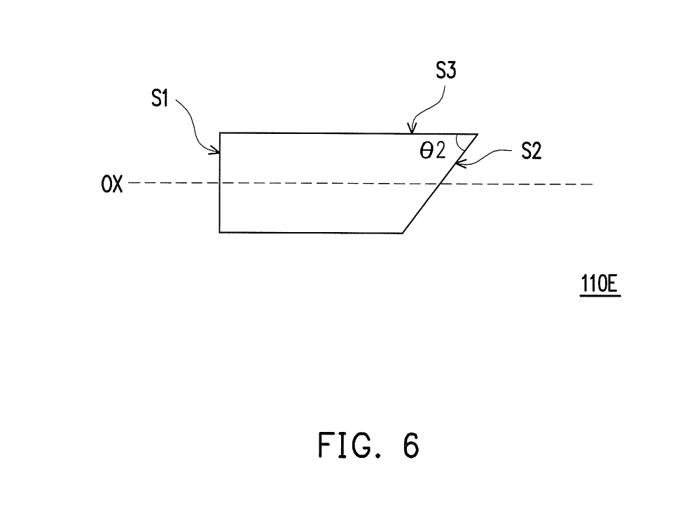

In the embodiments of FIG. 1 to FIG. 5, the light incidence surface S1 and the light emitting surface S2 of the light guide bars 110-110D are all parallel to each other, and the light incidence surface S1 and the light emitting surface S2 are all perpendicular to the optical axis OX. However, the invention is not limited thereto, and the light incidence surface S1 and the light emitting surface S2 can also be not parallel to each other. As shown in FIG. 6, the light guide bar 110E is similar to the aforementioned light guide bars 110-110D, and a difference therebetween is that the light emitting surface S2 is not parallel to the optical axis OX, and an interior angle θ2 included between the light emitting surface S2 and a top surface S3 of the light guide bar 110E can be smaller than 90 degrees. By designing the light emitting surface S2 to tilt downward, the dust adhered to the light emitting surface S2 can be decreased.

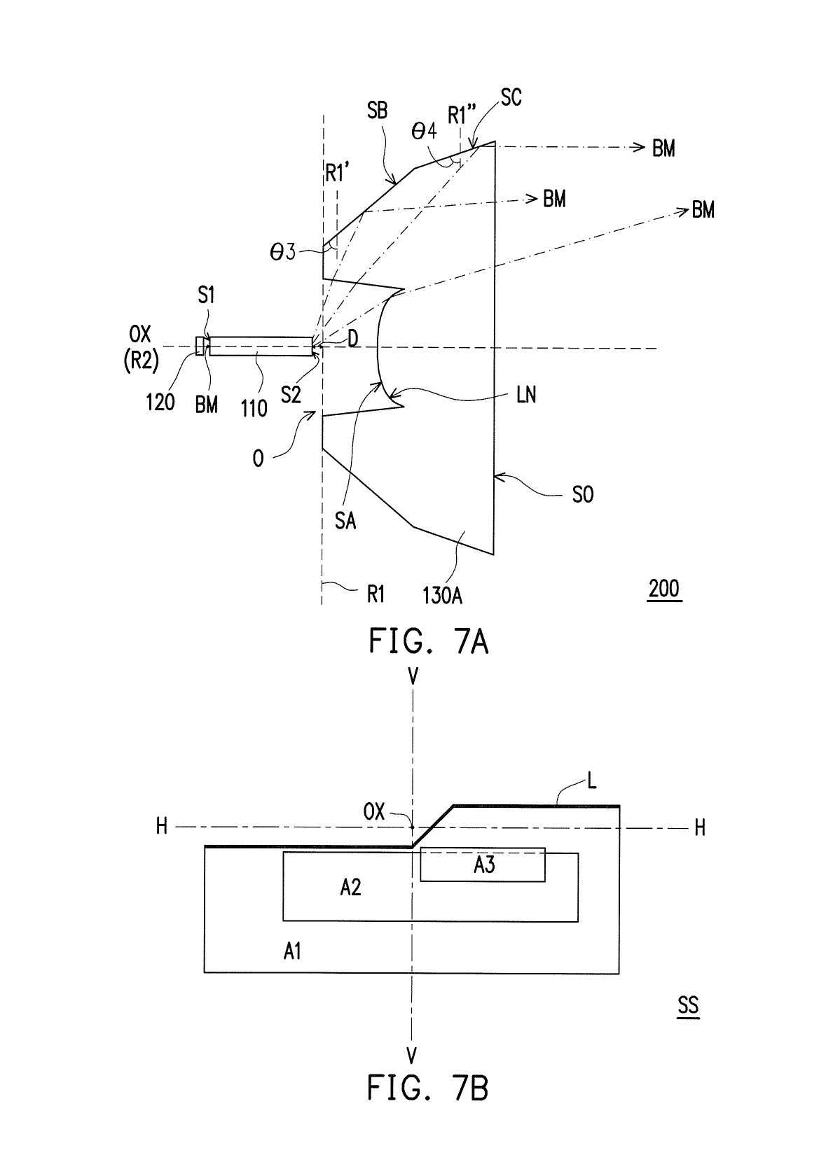

FIG. 7A is a cross-sectional view of a vehicle illumination apparatus according to a second embodiment of the invention. FIG. 7B is a schematic diagram of a light pattern projected by the vehicle illumination apparatus of FIG. 7A. Referring to FIG. 7A and FIG. 7B, the vehicle illumination apparatus 200 is similar to the vehicle illumination apparatus 100, wherein the same components are denoted by the same or similar referential numbers. A main difference between the vehicle illumination apparatus 200 and the vehicle illumination apparatus 100 lies in a design of the lens 130A.

As shown in FIG. 7A, the lens 130A has a main light spreading surface SA, a secondary light spreading surface SB and a light converging surface SC, wherein the optical axis OX passes through the main light spreading surface SA, the main light spreading surface SA is located in the light incidence recess LN, the secondary light spreading surface SB surrounds the main light spreading surface SA and is respectively connected to the light converging surface SC and the light incidence recess LN, and the light converging surface SC surrounds the secondary light spreading surface SB and is respectively connected to the light projection surface SO and the secondary light spreading surface SB. The main light spreading surface SA is adapted to project the light beam BM to a main light spreading region A1 of FIG. 7B, the secondary light spreading surface SB is adapted to project the light beam BM to a secondary light spreading region A2 of FIG. 7B, and the light converging surface SC is adapted to project the light beam BM to a light converging region A3 of FIG. 7B. Based on a suitable design, illuminance of the main light spreading region A1, the secondary light spreading region A2 and the light converging region A3 can be adjusted to comply with the requirement of related regulation. In FIG. 7A, only one secondary light spreading surface SB and one light converging surface SC are schematically illustrated, though the invention is not limited thereto, and the lens 130A may also have a plurality of the secondary light spreading surfaces SB and a plurality of the light converging surfaces SC.

In the embodiment, the main light spreading surface SA is a curved surface protruding towards the light incidence opening O. The curved surface may be rotationally symmetric to a second reference plane R2 parallel to the optical axis OX, though the invention is not limited thereto. The secondary light spreading surface SB and the light converging surface SC can be curved surfaces or planes, wherein the secondary light spreading surface SB is, for example, directly connected to the light converging surface SC, or the secondary light spreading surface SB and the light converging surface SC have a step therebetween, which is not limited by the invention. In FIG. 7A, reference planes R1′ and R1″ are, for example, perpendicular to the optical axis OX and are parallel to the first reference plane R1. The secondary light spreading surface SB and the reference plane R1′ include an acute angle θ3 in the lens 130A, and the light converging surface SC and the reference plane R1″ include an acute angle θ4 in the lens 130A. It should be noted that, the relationship between the relative magnitudes of the acute angles θ3 and θ4 is not limited by the invention, and by adjusting the acute angles θ3 and θ4, the light converging surface SC has a light beam collimating effect.

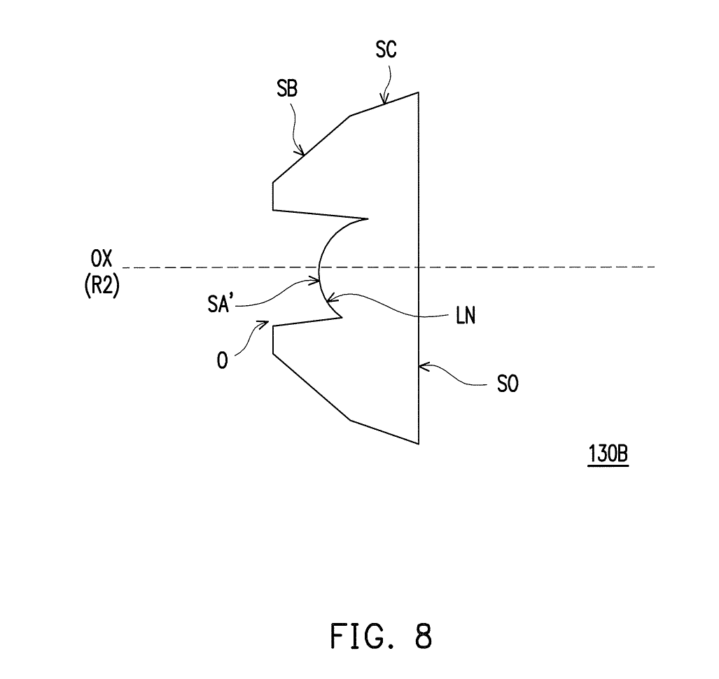

FIG. 8 is another cross-sectional view of the lens of FIG. 7A. Referring to FIG. 8, the lens 130B is similar to the aforementioned lens 130A, and a difference therebetween is that the main light spreading surface SA′ of the lens 130B is asymmetric to the second reference plane R2 parallel to the optical axis OX, such that the beam projected by the vehicle illumination apparatus is shifted downwards below the horizontal line H-H (referring to FIG. 7B), which avails satisfying the requirement of the regulations on the light pattern SS. The second reference plane R2 is, for example, parallel to the ground or perpendicular to the first reference plane R1, which is not limited by the invention.

In summary, the embodiments of the invention have at least one of the following advantages and effects. The light beam output by the light source first passes through the light guide bar and then enters the lens, and the light emitting surface of the light guide bar can be regarded as a virtual light source, and by changing a shape of the light emitting surface of the light guide bar, a light pattern output from the lens is adjusted, such that a cut-off line can be formed without using a light shielding plate. Therefore, the vehicle illumination apparatus of the invention may form the clear cut-off line without greatly decreasing utilization of light. Moreover, by designing the area of the light emitting surface of the light guide bar to be smaller than the cross-sectional area of the light incidence opening, the light emitting surface is equivalent to a point light source relative to the lens, such that a beam collimating effect of the lens is improved. Moreover, the light emitting surface of the light guide bar and the lens can be accurately aligned through mechanism assembling, so as to compensate a tolerance in components assembling of the light source and an error produced in light emitting element packaging, as such, the optical effect of the vehicle illumination apparatus can be improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the disclosure is intended to be dedicated to the public regardless of whether the element or component is explicitly recited in the following claims.

What is claimed is:

1. A vehicle illumination apparatus, comprising:
a light guide bar, having at least one light incidence surface and a light emitting surface, and a shape of the light emitting surface is a polygon having an interior angle not smaller than 180 degrees;
at least one light source, disposed adjacent to the at least one light incidence surface; and
a lens, disposed adjacent to the light emitting surface, and having an optical axis, a light incidence recess and a light projection surface opposite to the light incidence recess, the light incidence recess facing the light guide bar and having a light incidence opening, wherein a cross-sectional area of the light incidence opening on a first reference plane perpendicular to the optical axis is greater than an area of the light emitting surface of the light guide bar.

2. The vehicle illumination apparatus as claimed in claim 1, wherein an area of the light incidence surface of the light guide bar is greater than or equal to the area of the light emitting surface.

3. The vehicle illumination apparatus as claimed in claim 1, wherein a shape of the light incidence surface of the light guide bar is different from the shape of the light emitting surface.

4. The vehicle illumination apparatus as claimed in claim 1, wherein a shape of the light incidence surface of the light guide bar is the same to the shape of the light emitting surface.

5. The vehicle illumination apparatus as claimed in claim 1, wherein the at least one light source is adapted to emit a light beam to enter the light guide bar through the light incidence surface, and leave the light guide bar through the light emitting surface and is transmitted to the light incidence recess to enter the lens, and leave the lens through the light projection surface.

6. The vehicle illumination apparatus as claimed in claim 1, wherein the light incidence surface and the light emitting surface of the light guide bar are parallel to each other, and the light incidence surface and the light emitting surface are perpendicular to the optical axis.

7. The vehicle illumination apparatus as claimed in claim 1, wherein the light incidence surface and the light emitting surface of the light guide bar are not parallel to each other.

8. The vehicle illumination apparatus as claimed in claim 1, wherein the light guide bar is a solid structure.

9. The vehicle illumination apparatus as claimed in claim 1, wherein the light guide bar is a hollow structure, the light guide bar has an inner wall, and a reflection layer is formed on the inner wall.

10. The vehicle illumination apparatus as claimed in claim 1, wherein the number of the at least one light incidence surface and the number of the at least one light source are respectively two or more.

11. The vehicle illumination apparatus as claimed in claim 10, wherein the number of the at least one light incidence surface corresponds to the number of the at least one light source.

12. The vehicle illumination apparatus as claimed in claim 1, wherein the light source comprises at least one light emitting element.

13. The vehicle illumination apparatus as claimed in claim 1, wherein a distance between the light emitting surface of the light guide bar and the light incidence opening on the optical axis is greater than or equal to 0.

14. The vehicle illumination apparatus as claimed in claim 1, wherein the lens further has a main light spreading surface, at least one secondary light spreading surface and at least one light converging surface, the optical axis passes through the main light spreading surface, the secondary light spreading surface surrounds the main light spreading surface, and the light converging surface surrounds the secondary light spreading surface.

15. The vehicle illumination apparatus as claimed in claim 14, wherein the main light spreading surface is a curved surface protruding towards the light incidence opening.

16. The vehicle illumination apparatus as claimed in claim 14, wherein the secondary light spreading surface is a curved surface or a plane, and the light converging surface is a curved surface or a plane.

17. The vehicle illumination apparatus as claimed in claim 15, wherein the main light spreading surface is asymmetric to a second reference plane parallel to the optical axis.
